(19) United States
(12) Patent Application Publication
(10) Pub. No.: US 2002/0144122 A1
(43) Pub. Date: Oct. 3, 2002

(54) System and method for facilitating trusted transactions between businesses

(75) Inventors: Brian Haughan, Overijse (BE); Wally Verhanneman, Heverlee (BE)

Correspondence Address: Steve M. Perry, THORPE, NORTH & WESTERN, L.L.P., P.O. Box 1219, Sandy, UT, 84091-1219, US

(73) Assignee: S.W.I.F.T.

(21) Appl. No.: 09/825,415

(22) Filed: Apr. 3, 2001

(51) Int. Cl. H04L 9/00

(52) U.S. Cl. 713/176

(57) ABSTRACT

In an e-commerce system, on-line guarantees of party identity or other parameters can be obtained from banks acting as guarantors. A signed message is sent from a sending party to an intermediate service provider. The intermediate party obtains the identity of the receiver guarantor from the receiving party and the obtaining guarantees from both the sending and receiving party guarantors. The guaranteed message is then sent to the receiving party who replies with a receipt which is sent from the intermediate party to the sending party as a guaranteed receipt.

### FIELD OF THE INVENTION

This invention relates to a system and method for facilitating transactions between businesses. In particular, it is concerned with the provision of on-line guarantees by companies engaged in business-to-business (B2B) e-commerce.

### BACKGROUND TO THE INVENTION

When two companies transact over a network such as the Internet, some messages that are exchanged require guarantees. A guarantee is an obligation on behalf of one party to fulfil a commitment or an instruction and messages which represent such a commitment or instruction must be guaranteed. As a simple example, a receiver needs a guarantee about a sender's identity and the time and date a message was sent.

In business-to-business (B2B) transactions, companies could rely on their banks to provide such guarantees. Banks already provide loans and financial guarantees to customers. FIG. 1 illustrates a scenario where a receiver 10 obtains a guarantee by sending a ‘certificate valid’ message 12 to the bank 14 who issued the sender's certificate, the bank then sends the guarantee message 16 back to the receiver. This is unattractive as it requires extra work by the receiver who also may not have a relationship with the bank.

### SUMMARY OF THE INVENTION

The present invention aims to overcome the abovementioned disadvantages with the prior art method and apparatus.

In accordance with the invention, this aim is met by a system in which a guarantee is added to the message sent to the receiver. This arrangement greatly reduces the amount of messaging required.

In one embodiment of the invention, an intermediate party is arranged between the sending party and the receiving party. The intermediate party receives messages, which may be signed, from the sending party, and obtains a guarantee from a sending party guarantor. The intermediate party then sends the message, as a guaranteed message, to the receiving party.

In one embodiment, the intermediate party also obtains a guarantee from the receiving party guarantor. When a message is received at the receiving party, a receipt is sent to the intermediate party which sends it as a guaranteed receipt to the sending party.

Preferably, on receipt of a message, the intermediate party logs it, adds a timestamp and reference and verifies any signature. It then determines the sender's identity and its guarantor's identity.

Preferably, guaranteed messages are logged before they are sent to the receiving party. The receipts are also logged before being sent by the intermediate party as guaranteed receipts.

Embodiments of the invention have the advantage that message flow is greatly simplified. They have the further advantage that customers can obtain on-line guarantees for e-commerce transactions from banks.

A preferred embodiment has the further advantage that the intermediate party, through its logging, timestamping and referencing of messages, can provide an on-line notarisation enabling resolution of disputes between parties.

### BRIEF DESCRIPTION OF THE DRAWINGS

Embodiments of the invention will now be described, by way of example only, and with reference to the accompanying drawings in which:

FIG. 1 is an overview of a known model for providing guarantees;

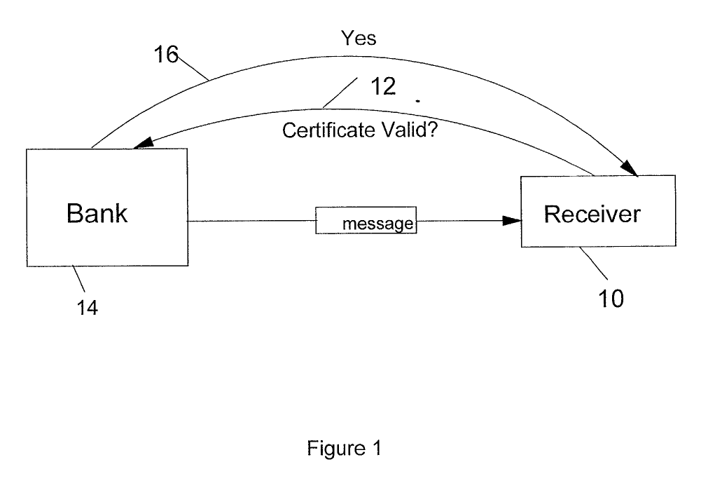

FIG. 2 is an overview of the model for providing guarantees adopted by the present invention;

FIG. 3 illustrates the contractual relationship between parties to a transaction;

FIG. 4 illustrates the levels of contractual relationships in the system;

FIG. 5 illustrates the message flow in a system embodying the present invention;

FIG. 6 is a schematic view of the topology of a system embodying the invention.

### DESCRIPTION OF PREFERRED EMBODIMENT

Referring to the figures, the purpose of the system is to facilitate trusted business-to-business (B2B) e-commerce by enabling businesses to obtain on-line guarantees from their bank. Banks can use the system to be described to provide on-line guarantees and e-trust services to corporate customers.

The system to be described operates over a communications network, preferably a combination of the Internet and a private network. In essence it is a messaging service which adds guarantees to e-commerce messages, enabling trusted e-commerce.

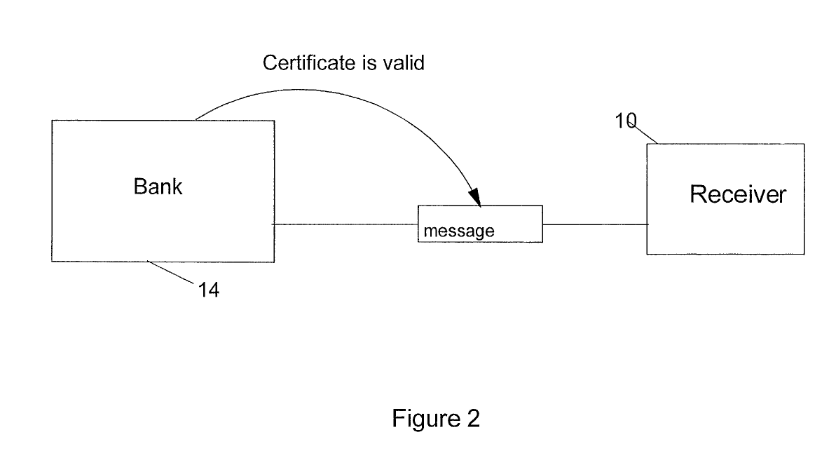

The system to be described operates on the principle that guarantees are attached before they are received by a receiver. The receiver's guarantor may also be involved. This is illustrated in FIG. 2 in which the bank is shown at 14 and the receiver at 10.

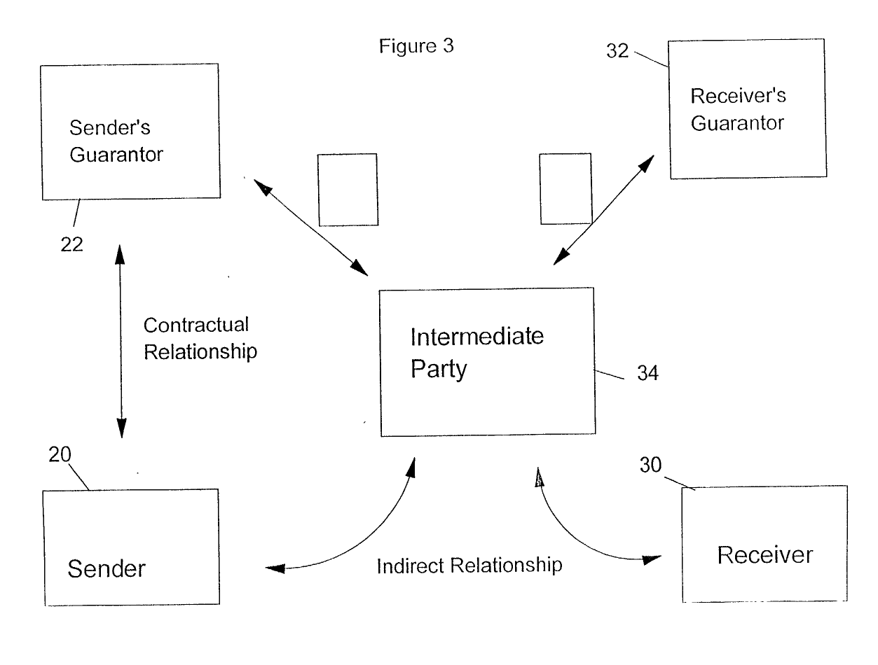

FIG. 3 shows the contractual relationship between the various parties to a transaction. The sender 20 and receiver 30 each have a contractual relationship with their own guarantors, 22 and 32 Guarantees can be exchanged by the guarantors through a third party 34 establishing an indirect relationship between the sender and the receiver. Such an arrangement may be used to provide more than the provision of identity guarantees and may extend to the provision of on-line notarisation, a legal framework that makes messages binding, and guarantees such as the ability to pay. The system operates by providing a guarantee service to which banks or other institutions sign up as guarantors and businesses sign up as customers.

Messages exchanged between senders and receivers may be made legally binding by establishing contractual relationships between senders and receivers and their banks and by establishing contractual relationships between senders, receivers, their banks and the service providers 34. Message exchange also takes place under the terms of Contract Law.

The contractual relationship between subscribers and guarantors will set out details of service levels, prices, procedures and other factors determining the provision of guarantee services as the guarantor to the subscriber. It may refer to a Certification Practices Statement.

The contractual relationship between the Guarantors and the service providers defines service levels between the service provider and the guarantors as well as defining the service levels the guarantor can promise to provide the subscribers.

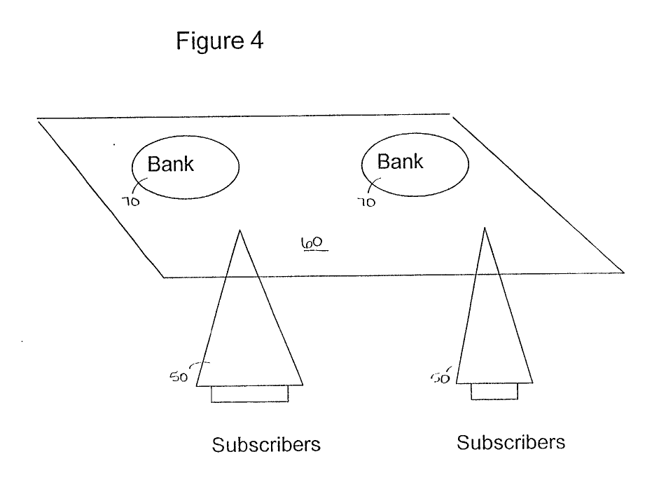

This two tier contractual relationship is illustrated in FIG. 4 with the subscriber shown at 50, the service provider at 60 and the guarantors at 70.

Each of the levels of contract may refer to a rulebook established by the service provider to which the parties are then bound. Thus, the guarantors have an explicit relationship with the service provider 34 and an implied relationship with other guarantors who have a contractual relationship with the service provider.

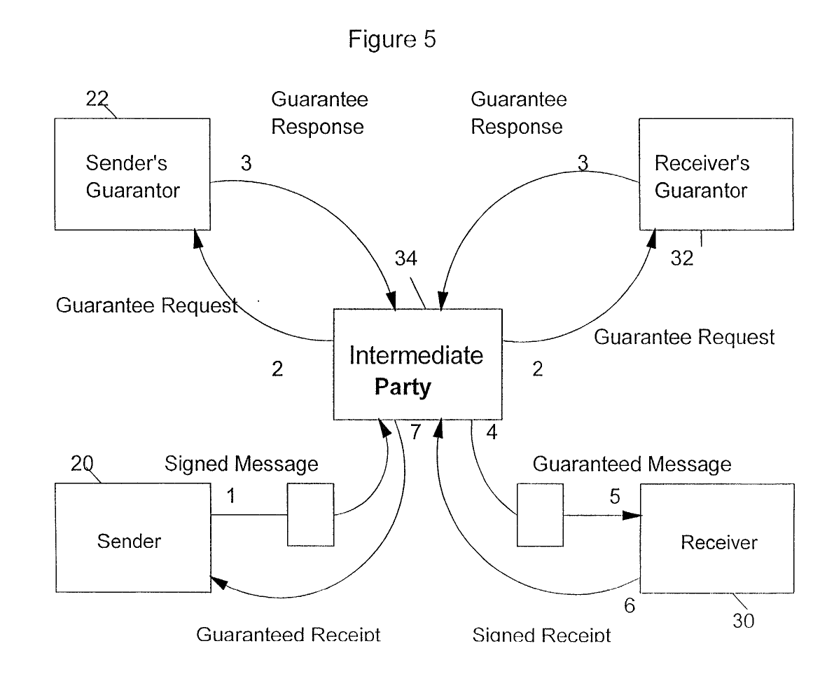

Referring to FIG. 5, the message flow in a transaction will now be described.

The purpose of following sequence is for the sender to send a signed message to a receiver which is received by the receiver as a guaranteed message.

The first stage is for the sender to send a signed message to the service provider. In FIG. 5 this is shown by pathway 1. The signed message requires a bank's guarantee and is created by any suitable application at the sender, for example a browser or an ERP system which signs the message and sends it to the service provider.

At the second stage, the service provider receives the signed message from the sender, logs it and adds to it a timestamp and individual reference number. It then verifies the signature using its public key. The use and verification of signed electronic messages is well understood and will not be described further.

The service provider then interprets the received signed message to determine the sender's identity, its public key and the identity of the sender's guarantor. It then establishes a connection to the receiver to obtain its public key and its guarantor's identity. The service provider will then send a guarantee request to the sender's guarantor relative to the sender and to the receiver's guarantor relative to the receiver.

These two guarantee request messages are shown at 2 in FIG. 5. Thus, in this stage, the service provider 34 has requested guaranteed identity from the guarantors 22,32.

At the next stage, shown as 3 in FIG. 5, the guarantors confirm, respectively, the identity of the sender and receiver to the service provider. The guarantors each receive and process the guarantee request made by the service provider and send a guarantee response back to the service provider.

The service provider then forwards the guaranteed message to the receiver as shown at 4 in FIG. 5. This can rake place once the two guarantors have confirmed the guarantee. The service provider constructs a guaranteed message using the original signed message and the timestamp and reference number that were applied when the message was received at the service provider. The guaranteed message is first logged and then sent to the receiver.

The receiver, at 5, receives the guaranteed message from the service provider, authenticates the service provider's signature which is attached to the message and can then rely on that message.

The receiver then acknowledges receipt of the message by returning a signed receipt to the service provider, illustrated at 6 in FIG. 5. The service provider then constructs a guaranteed receipt by adding the guaranteed identity obtained from the receiver's guarantor to the signed receipt, logs the guaranteed receipt and forwards it to the initial sender. This step is shown at 7 in FIG. 5.

From the description given above, it will be appreciated that messages passing through the service provider 34 are timestamped and logged. Timestamping guarantees that a message was sent at a universal, commonly accepted time. Logging allows messages to be retrieved at a later date so that disputes can be resolved. Thus, the system and method described can be used to provide an on-line notarisation service.

As mentioned above, the contractual agreement between the various parties may refer to a rulebook. The following description sets out a summary of the major obligations on the subscribers, guarantors and service provide that may be required.

Subscribers

Subscribers are required to manage their keys and security in a responsible manner, for example by maintaining exclusive access to the private key. Senders must send signed messages to the service providers requesting guarantees when asked by the receiver and be bound by guaranteed messages forwarded by the service provider to the same extent, to the same extent and with the same effect of law as if it had existed in a manually signed form. Likewise, receivers must notify the sender when a message must be routed through the service provider, must receive guaranteed messages from the service provider, rely on the sender's identity, public key and signature and promptly return a signed receipt to the sender.

Guarantors

Guarantors are required to maintain subscriber records, verify that a sender's private key corresponds to its public key and ensure that subscriber identities and public keys are unique. They must revoke a public key when requested by a subscriber. Guarantors support subscribers by providing first line support and arbitration in the event of a dispute.

Guarantors also confirm guarantees by receiving a guarantee request from the service provider and providing the response in a guarantee response to the service provider.

Guarantors connect to and communicate with the service provider's server and manage the liability risk of its services.

Service Provider

The service provider is required to construct and forward guaranteed messages to the receiver by receiving messages from the server; send guarantee requests to the parties' guarantors; obtain guarantee responses from the guarantors; and construct guaranteed messages from the signed message if both guarantors confirm the guarantees. Furthermore the service provider is required to receive signed receipts from the receiver and construct and forward a guaranteed receipt to the sender. It is obliged to protect the security of its server and ensure that it can operate at all times and produce evidence to guarantors in the event of disputes.

It will be appreciated that the obligations set out above are merely one example of how the system can work What the subscribers are required to do with their keys is set out in the contract with the guarantor. The role of the service provider may be limited to provide a norm for this contract.

The example described above, and the associated rules, relate specifically to the provision of guaranteed identity by banks. It will be appreciated that the system can be adapted to provide other guarantees without departing from the scope of the invention. Examples include the ability to pay, authorisation and creditworthiness. The message flow and rulebooks for each of these will be different.

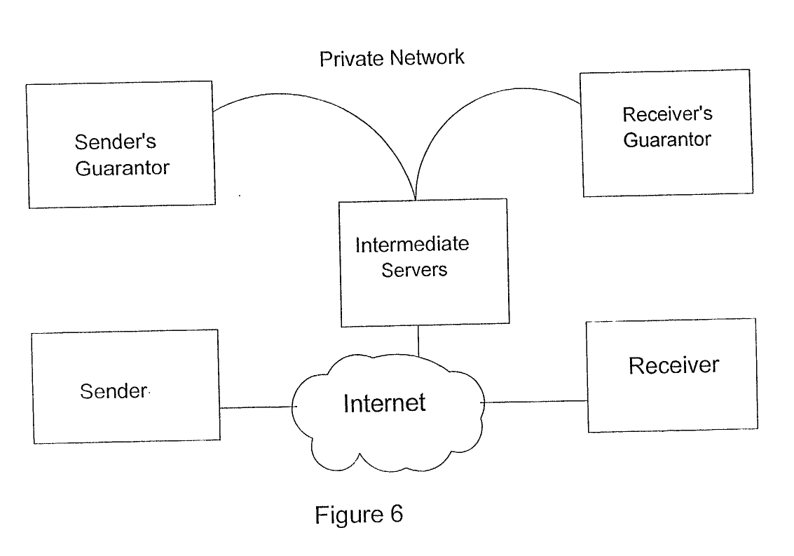

FIG. 6 illustrates, schematically, the topology of a preferred implementation of the invention. The service supplier is a server which incorporates a message routing function using Internet protocols. The communications between the guarantors and the service provider are preferably across a dedicated communications pathway such as SWIFTNet Interact. The system supports Identrust compliant X.509v3 certificates and applications. The communications between the service provider and the subscribers are via the Internet using standard Internet communications protocols. The messages are preferably sent in XML format with the XML envelope embedding the actual message and X.509v3 certificate.

It will be appreciated from the foregoing that the method and system embodying the invention enable a subscriber to obtain guarantees from its bank, such as confirmation that a certificate issued by the bank and used to sign an e-commerce message is still valid. The counterparty receiving the message has the guarantee that the identity of the sender has been verified. The receiver has the additional guarantee that the messages have been logged and timestamped by the service provider, which can be relied on in the event of a dispute. The sender has the same benefit as the receiver returns a receipt which is guaranteed by the and logged by the service provider. Businesses may exchange messages over the Internet, or any other communications network via the service provider to enable banks to apply trust, or guarantees, to the receiver when the message is on its way to the receiver.

From the point of view of the financial institution, the method and system embodying the invention provide a platform that banks can use to provide on-line guarantees and e-trust services to corporate customers enabling them to play an active role in B2B e-commerce. The bank can maintain a direct relationship with its customers as they market, sell and support the system using their own e-trust brand, to their customers who sign an agreement with their bank rather than with the service provider. Banks effectively intercept e-commerce messages sent between two businesses and apply guarantees to these messages.

Various modifications and developments beyond those already mentioned are possible and will occur to those skilled in the art without departing from the spirit and scope of the invention.

1. A method of sending an electronic message from a sending party to a receiving party, the message being received by the second party with a guarantee, the method comprising the steps of:
sending a guarantee request from said sending party to a guarantor;
attaching a guarantee received from the guarantor to said message; and forwarding said guaranteed message to said receiving party.

2 A method according to claim 1, wherein said step of sending said guarantee request from said sending party to a guarantor comprises the steps of:
sending said message from said sending party to an intermediate party; and
sending the guarantee request from said intermediate party to a sender's guarantor..

3. A method according to claim 1, wherein prior to said step of sending a message requesting a guarantee, said intermediate party performs the steps of:
logging said message from said sending party;
adding a timestamp to said message;
adding a reference to said message; and
verifying said message.

4. A method according to claim 3, wherein said message is a message signed with a signature, and the step of verifying said message further comprises verifying the signature.

5. A method according to claim 3, wherein said intermediate party performs the further steps of:
determining the sending party's identity;
determining the guarantor's identity; and
determining the identity of the receiving party's guarantor.

6. A method according to claim 5, wherein the step of determining the identity of the receiving party's guarantor comprises contacting the receiving party.

7. A method according to claim 5, wherein the step of sending said guarantee request from the sending party to a guarantor further comprises:
sending a guarantee request message from the intermediate party to the receiving party's guarantor.

8. A method according to claim 2, wherein the step of sending said message further comprises receiving a guarantee from the sender's guarantor, and said step of attaching the guarantee to the message is performed by the intermediate party.

9. A method according to claim 5, wherein the step of sending said message further comprises receiving a guarantee from the receiver's guarantor.

10. A method according to claim 8, wherein the step of attaching the guarantee to the message includes attaching a timestamp and reference to the message, said timestamp and reference having been assigned by the intermediate party on receipt of the message from the sender by the intermediate party.

11. A method according to claim 10, comprising receiving the guaranteed message at the receiving party from the intermediate party; and verifying a signature applied to the message by the intermediate party.

12. A method according to claim 1, further comprising sending a receipt from the receiving party to the intermediate party after receipt as the guaranteed message.

13. A method according to claim 12, wherein the receipt is a signed receipt.

14. A method according to claim 12, comprising forwarding the guaranteed message to the sending party with the guarantee received from the receiving party's guarantor.

15. A method of sending a guaranteed message from a sending party to a receiving party, the method comprising the steps of:
sending an electronic message from the sending party to an intermediate party;
obtaining a guarantee at the intermediate party;
on receipt of the guarantee, constructing a guaranteed message from the electronic message and the guarantee; sending the guaranteed message from the intermediate party to the receiving party.

16. A method according to claim 1, wherein the message sent from the sending party includes a signature, comprising:
logging the message on receipt at the intermediate party;
adding a timestamp and a reference to the message and verifying the signature.

17. A method according to claim 16, wherein the step of constructing the guaranteed message uses the received signed message, the timestamp and the reference.

18. A method according to claim 15, wherein, on receipt of the guaranteed message at the receiving party, the receiving party sends a receipt to the intermediate party.

19. A method according to claim 18, wherein the receipt is signed.

20. A method according to claim 18, wherein, when the receipt is received by the intermediate party, the intermediate party sends a guaranteed receipt to the sending party.

21. A method according to claim 15, further comprising the step of:
obtaining a guarantee from the receiving party guarantor at the intermediate party; and wherein the construction and sending of the guaranteed message occurs only when guarantees are received from the sending party guarantor and the receiving party guarantor.

22. A method according to claim 21, wherein on receipt of the guaranteed message at the receiving party the receiving party sends a receipt to the intermediate party, and the intermediate party adds the guarantee received from the receiving party's guarantor to the receipt to form a guaranteed receipt and sends the guaranteed receipt to the sending party.

23. A method according to claim 21, wherein the step of obtaining a guarantee from a receiving party guarantor by the intermediate party comprises requesting from the receiving party the identity of the receiving party's guarantor and sending a guarantee request to the receiving party guarantor on receipt of their identity.

24. A method of sending a guaranteed message from a sending party to a receiving party comprising the steps of:
sending a signed electronic message from the sending party to an intermediate party;
establishing, at the intermediate party, the identity of a receiving party guarantor;
sending a guarantee request to a sending party guarantor and the receiving party guarantor;
on receipt of a guarantee from each of the sending party guarantor and receiving party guarantor, sending a guaranteed message from the intermediate party to the receiving party; and
sending a guaranteed receipt from the intermediate party to the sending party after the guaranteed message has been received by the receiving party.

25. A method according to claim 24, comprising, on receipt of the signed message by the intermediate party;
logging the signed message;
attaching a timestamp to the signed message;
attaching a reference to the signed message; and
verifying the signature.

26. A method according to claim 25, wherein the step of establishing the receiving party's guarantor comprises sending a guarantor identity request from the intermediate party to the receiving party.

27. A method according to claim 26, wherein the message is encrypted using public/private key encryption, further comprising requesting the receiving party's public key when the guarantor identity request is sent.

28. A method according to claim 24, wherein prior to sending the guaranteed receipt to the sending party by the intermediate party, the receiving party sends a signed receipt to the intermediate party.

29. A method of providing on-line notarisation for electronic messages sent from a sending party to a receiving party, comprising the steps of:
sending a message from the sending party to an intermediate party;
logging receipt of the message at the intermediate party;
applying a timestamp to the message;
assigning a reference to the message;
obtaining a guarantee from a sending party guarantor at the intermediate party;
and, on receipt of the guarantee, sending a guaranteed message from the intermediate party to the receiving party.

30. A method according to claim 29, further comprising, on receipt of the guaranteed message at the receiving party:
sending a receipt to the intermediate party;
logging the receipt at the intermediate party;
sending a guaranteed receipt to the sending party.

31. A method according to claim 29, wherein the guaranteed message is logged before it is sent by the intermediate party to the receiving party.

32. Apparatus for sending an electronic message from a sending party to a receiving party, the message being received by the second party with a guarantee, comprising:
a message sending device for sending the message from said sending party to a guarantor;
means for attaching a guarantee to said message; and
means for forwarding said guaranteed message to said receiving party.

33. Apparatus according to claim 32, further including:
an intermediate party; and
means at the intermediate party for sending a message from the intermediate party to a sender's guarantor requesting a guarantee.

34. Apparatus according to claim 32, wherein the intermediate party comprises:
a logger for logging said message from said sending party;
a timestamper for adding a timestamp to said message;
a reference adder for adding a reference to said message; and
a verifier for verifying the message.

35. Apparatus according to claim 34, wherein said message is signed with a signature, and the verifier for said message further comprises means for verifying the signature.

36. Apparatus according to claim 34, wherein said intermediate party further comprises a sending party identifier for determining the sending party's identity;
a guarantor identifier for determining the guarantor's identity; and
a receiving party guarantor identifier for determining the identity of the receiving party's guarantor.

37. Apparatus according to claim 36, wherein the receiving party guarantor identifier comprises means for contacting the receiving party.

38. Apparatus according to claim 36, wherein the message sending device further comprises:
means for sending a guarantee request message from the intermediate party to the receiving party's guarantor.

39. Apparatus according to claim 33, wherein the message sending device further comprises means for receiving a guarantee from the sender's guarantor; and said intermediate device includes said means for attaching the guarantee to the message is performed by the intermediate party.

40. Apparatus according to claim 36, wherein the electronic message sending device further comprises means for receiving a guarantee from the receiver's guarantor.

41. Apparatus according to claim 39, wherein the means for attaching the guarantee to the message includes:
means for attaching a timestamp and reference to the messages, said timestamp and reference having been assigned by the intermediate party on receipt of the message from the sender by the intermediate party.

42. Apparatus according to claim 41, comprising a receiving party for receiving the guaranteed message from the intermediate party, the receiving party having a verifier for verifying a signature applied to the message by the intermediate party.

43. Apparatus according to claim 32, further comprising a receipt sender for sending a receipt from the receiving party to the intermediate party after receipt of the guaranteed message.

44. Apparatus according to claim 43, wherein the receipt sender sends a signed receipt.

45. Apparatus according to claim 43, wherein the intermediate party comprises means for forwarding the guaranteed message to the sending party with the guarantee received from the receiving party's guarantor.

46. Apparatus for sending a guaranteed message from a sending party to a receiving party, comprising:
a sending party; an intermediate party; a guarantor; and a receiving party:
wherein the sending party comprises a message sender for sending the message to the intermediate party;
the intermediate party comprises means for obtaining a guarantee from the sending party guarantor; and a guaranteed message forming and sending device for, on receipt of the guarantee, constructing a guaranteed message and sending the guaranteed message to the receiving party.

47. Apparatus according to claim 46, wherein the message sent from the sending party includes a signature, comprising, at the intermediate party, a message logger for logging the message on receipt, a timestamper for adding a timestamp, a referencer for adding a reference to the message, and a verifier for verifying the signature.

48. Apparatus according to claim 47, wherein the guaranteed message constructing device attaches the timestamp generated by the timestamper and the reference generated by the reference to the signed message.

49. Apparatus according to claim 46, comprising a receipt sender at the receiving party for sending a receipt on receipt of the guaranteed.

50. Apparatus according to claim 49, wherein the receipt sender sends a signed receipt.

51. Apparatus according to claim 49, wherein the intermediate party includes a guaranteed receipt sender for sending a guaranteed receipt to the sender party when the receipt is received from the receiving party.

52. Apparatus according to claim 46, wherein the intermediate party further comprises means for obtaining a guarantee from a receiving party guarantee at the intermediate party; and wherein the means for constructing and sending the guaranteed message constructs and sends the message occurs only when guarantees are received from the sending party guarantor and the receiving party guarantor.

53. Apparatus according to claim 52, wherein the receiving party comprises a receipt sender which, on receipt of the guaranteed message at the receiving party, the receiving party sends a receipt to the intermediate party and the intermediate party comprises a guaranteed receipt sender which adds the guarantee received form the receiving party's guarantor to the receipt to form a guaranteed receipt and sends the guaranteed receipt to the sending party.

54. Apparatus according to claim 42, wherein the intermediate party further includes means for requesting the identity of the receiving party's guarantor and sending a guarantee request to the receiving party guarantor on receipt of that identity.

55. Apparatus for sending a guaranteed electronic message from a sending party to a receiving party, comprising: an intermediate party, wherein the sending party comprises a message sender for sending a signed message to an intermediate party; the intermediate party comprising:
a guarantor identifier for establishing the identity of a receiving party guarantor;
a guarantor request for sending a guarantee request to a sending party guarantor and the receiving party guarantor;
a guaranteed message sender which on receipt of a guarantee from each of the sending party guarantor and receiving party guarantor, sends a guaranteed message from the intermediate party to the receiving party; and
a guaranteed receipt sender for sending a guaranteed receipt from the intermediate party to the sending party after the guaranteed message has been received by the receiving party.

56. Apparatus according to claim 55, wherein the intermediate party further comprises;
a logger for logging the signed message;
a timestamper for attaching a timestamp to the signed message;
a referencer for attaching a reference to the signed message; and
a verifier for verifying the signature.

57. Apparatus according to claim 56, wherein the guarantor identifier comprises means for sending a guarantor identity request from the intermediate party to the receiving party.

58. Apparatus according to claim 57, wherein the message is encrypted using public/private key encryption, further comprising a public key requester for requesting the receiving party's public key when the guarantor identity request is sent.

59. Apparatus according to claim 55, comprising a receipt sender for sending a signed receipt to the intermediate party prior to sending the guaranteed receipt to the sending party by the intermediate party.

60. Apparatus for providing on-line notarisation for electronic messages sent from a sending party to a receiving party, comprising: an intermediate party;
a message sender for sending a message from the sending party to the intermediate party;
a logger for logging receipt of the message at the intermediate party;
a timestamper for applying a timestamp to the message;
a referencer for assigning a reference to the message;
a guarantee obtainer for obtaining a guarantee from a sending party guarantor at the intermediate party; and
a guaranteed message sender for sending, on receipt of the guarantee, a guaranteed message from the intermediate party to the receiving party.

61. Apparatus according to claim 60, further comprising:
a receipt sender for sending a receipt from the receiving party to the intermediate party on receipt of the guaranteed message at the receiving party;
a logger for logging the receipt at the intermediate party; and
a guaranteed receipt sender for sending a guaranteed receipt to the sending party.

62. Apparatus according to claim 60, wherein the logger logs the guaranteed message before it is sent by the intermediate party to the receiving party.

63. An intermediate agent for use in a system for sending an electronic message from a sending party to a receiving party, the message being received by the sending party with a guarantee, the system including the sending party, the receiving party, and a sending party guarantor; wherein the intermediate agent is arranged to communicate with the sending party, the receiving party and the sending party guarantor and comprises:
means for obtaining a guarantee relating to the sending party from the sending party guarantor; and
means for sending the received message as a guaranteed message to the receiving party.

64. An intermediate agent according to claim 63, wherein the system further comprises: a receiving party guarantor; and the intermediate agent further comprises means for obtaining a guarantee relating to the receiving party from the receiving party guarantor.

65. An intermediate agent according to claim 64, further comprising means for receiving a receipt from the receiving party when the receiving party has received a guaranteed message; and means for sending the receipt as a guaranteed receipt to the sending party.

66. An intermediate agent according to claim 63, wherein the means for receiving messages from the send party comprises a logger for logging the messages.

67. An intermediate agent according to claim 63, wherein the means for receiving messages from the sending party comprises a timestamper for timestamping received messages.

68. An intermediate agent according to claim 63, wherein the means for receiving messages from the sending party comprises a referencer for assigning references to received messages.

69. An intermediate agent according to claim 63, wherein the received messages are signed and the means for receiving messages further comprises a verifier for verifying the signature on the messages.

70. An intermediate agent according to claim 63, wherein the means for sending the received message includes a logger for logging the guaranteed messages.

71. An intermediate agent according to claim 64, wherein the means for obtaining a guarantee relating to the receiving party includes means for obtaining from the receiving party guarantor.
